(19) United States
(12) Patent Application Publication
(10) Pub. No.: US 2023/0307654 A1
(43) Pub. Date: Sep. 28, 2023

(54) ALL SOLID STATE BATTERY AND ALL SOLID STATE BATTERY SYSTEM

(71) Applicant: TOYOTA JIDOSHA KABUSHIKI KAISHA, Toyota-shi Aichi-ken (JP)

(72) Inventor: Ximeng LI, Susono-shi Shizuoka-ken (JP)

(73) Assignee: TOYOTA JIDOSHA KABUSHIKI KAISHA, Toyota-shi Aichi-ken (JP)

(21) Appl. No.: 18/121,857

(22) Filed: Mar. 15, 2023

(30) Foreign Application Priority Data
Mar. 24, 2022 (JP) 2022-047821

(51) Int. Cl. H01M 4/62; H01M 4/38; H01M 4/04; H01M 10/63; H01M 10/0562

(52) U.S. Cl. CPC H01M 4/626; H01M 4/382; H01M 4/0404; H01M 10/63; H01M 10/0562; H01M 2004/027

(57) ABSTRACT

A main object of the present disclosure is to provide an all solid state battery in which occurrence of short circuit is inhibited. The present disclosure achieves the object by providing an all solid state battery comprising an anode including at least an anode current collector, a cathode, and a solid electrolyte layer arranged between the anode and the cathode; wherein a protective layer containing Mg is arranged between the anode current collector and the solid electrolyte layer; the protective layer includes a mixture layer including a Mg-containing particle containing the Mg, and a solid electrolyte; and in the protective layer, Mg concentration increases stepwisely or continuously from a first surface which is the solid electrolyte layer side towards a second surface which is the anode current collector side.

### CROSS-REFERENCE TO RELATED APPLICATIONS

This application is based upon and claims the benefit of priority of the prior Japanese Patent Application No. 2022-047821, filed on Mar. 24, 2022, the entire contents of which are incorporated herein by reference.

### TECHNICAL FIELD

The present disclosure relates to an all solid state battery and an all solid state battery system.

### BACKGROUND ART

An all solid state battery is a battery including a solid electrolyte layer between a cathode and an anode, and one of the effects thereof is that the simplification of a safety device may be more easily achieved compared to a liquid-based battery including a liquid electrolyte containing a flammable organic solvent.

For example, Patent Literature 1 discloses that an all solid state battery, which utilizes a deposition and dissolution reactions of a metal lithium as an anode reaction, includes a metal Mg layer formed on an anode current collector. Also, Patent Literature 2 discloses that an all solid state battery includes, between an anode layer and a solid electrolyte layer, a protective layer including a composite metal oxide represented by Li-M-O.

### CITATION LIST

### Patent Literatures

Patent Literature 1: Japanese Patent Application Laid-Open (JP-A) No. 2020-184513
Patent Literature 2: JP-A No. 2020-184407

### SUMMARY OF DISCLOSURE

### Technical Problem

From the viewpoint of improving performance of an all solid state battery, restraining the occurrence of short circuit (such as slight short circuit that degrades performance) is required. The present disclosure has been made in view of the above circumstances and a main object thereof is to provide an all solid state battery in which occurrence of short circuit is inhibited.

### Solution to Problem

In order to achieve the object, the present disclosure provides an all solid state battery comprising an anode including at least an anode current collector, a cathode, and a solid electrolyte layer arranged between the anode and the cathode; wherein a protective layer containing Mg is arranged between the anode current collector and the solid electrolyte layer; the protective layer includes a mixture layer including a Mg-containing particle containing the Mg, and a solid electrolyte; and in the protective layer, Mg concentration increases stepwisely or continuously from a first surface which is the solid electrolyte layer side towards a second surface which is the anode current collector side.

According to the present disclosure, a protective layer containing a Mg-containing particle and a solid electrolyte is arranged between the anode current collector and the solid electrolyte layer, and further, in the protective layer, Mg concentration increases stepwisely or continuously from the first surface towards the second surface, and thus occurrence of sort circuit is inhibited in the all solid state battery.

In the disclosure, the protective layer may include a Mg layer containing the Mg but not containing a solid electrolyte, in a position closer to the anode current collector side than the mixture layer side.

In the disclosure, the Mg layer may be a metal thin film containing the Mg.

In the disclosure, a thickness of the metal thin film may be 1 nm or more and 5000 nm or less.

In the disclosure, the Mg layer may be a layer including the Mg-containing particle containing the Mg.

In the disclosure, the protective layer may include a plurality of the mixture layer.

In the disclosure, the anode may include an anode active material layer containing a deposited Li between the anode current collector and the solid electrolyte layer.

In the disclosure, the anode may not include an anode active material layer containing a deposited Li between the anode current collector and the solid electrolyte layer.

The present disclosure also provides an all solid state battery system comprising: the above described all solid state battery; and a control device that controls charge and discharge of the all solid state battery; wherein the control device controls the all solid state battery to be charged or discharged at a rate of 0.5 C or more.

According to the present disclosure, even when the above described all solid state battery is charged or discharged at a comparatively high rate, occurrence of short circuit is inhibited in the all solid state battery system.

### Effects of Disclosure

The present disclosure exhibits an effect of providing an all solid state battery in which occurrence of short circuit is inhibited.

### BRIEF DESCRIPTION OF DRAWINGS

FIG. 1 is a schematic cross-sectional view exemplifying the all solid state battery in the present disclosure.

FIG. 2A is a schematic cross-sectional views exemplifying the all solid state battery in the present disclosure.

FIG. 2B is a schematic cross-sectional view exemplifying the all solid state battery in the present disclosure.

FIG. 3 is a schematic cross-sectional view exemplifying the all solid state battery in the present disclosure.

FIG. 4A is a schematic cross-sectional view exemplifying the protective layer in the present disclosure.

FIG. 4B is a schematic cross-sectional view exemplifying the protective layer in the present disclosure.

FIG. 5 is a schematic cross-sectional view exemplifying the protective layer in the present disclosure.

FIG. 6 is a schematic diagram exemplifying the all solid state battery system in the present disclosure.

FIG. 7A is a schematic cross-sectional view exemplifying a part of the all solid state batteries produced in Example.

FIG. 7B is a schematic cross-sectional view exemplifying a part of the all solid state batteries produced in Comparative Example 1.

FIG. 7C is a schematic cross-sectional view exemplifying a part of the all solid state batteries produced in Comparative Example 2.

### DESCRIPTION OF EMBODIMENTS

The all solid state battery and the all solid state battery system in the present disclosure will be hereinafter explained in details.

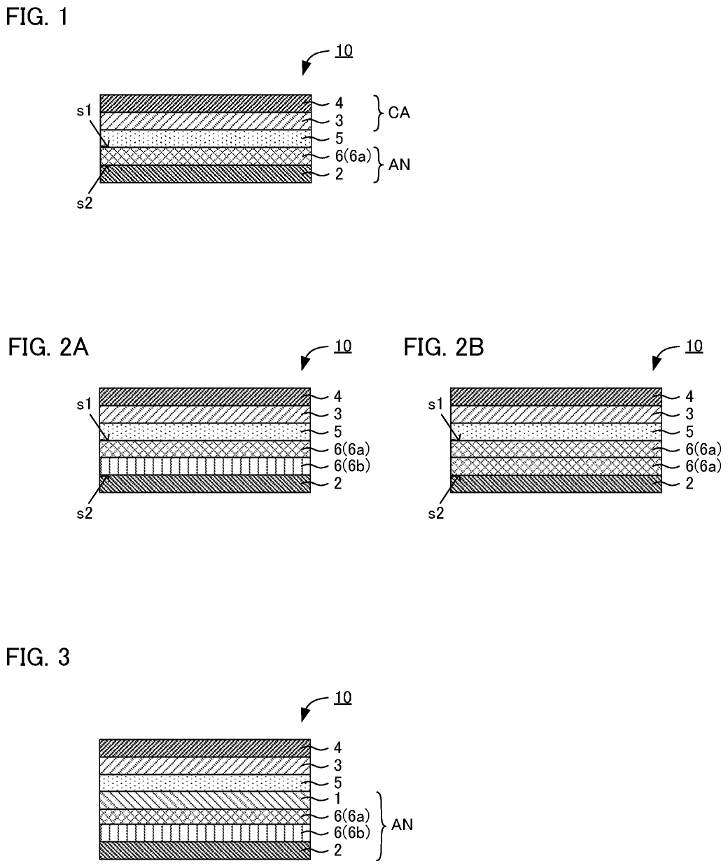

FIG. 1 is a schematic cross-sectional view exemplifying the all solid state battery in the present disclosure. All solid state battery 10 illustrated in FIG. 1 includes anode AN including anode current collector 2, cathode CA including cathode active material layer 3 and cathode current collector 4, and solid electrolyte layer 5 arranged between the anode AN and the cathode CA. Further, in FIG. 1, between the anode current collector 2 and the solid electrolyte layer 5, protective layer 6 containing Mg is arranged. The protective layer 6 includes a mixture layer 6a including a Mg-containing particle containing the Mg, and a solid electrolyte. Incidentally, as shown in FIG. 1, the protective layer 6 may be regarded as a constituent element of the anode AN.

In the protective layer 6, Mg concentration increases stepwisely or continuously from a first surface s1 which is the solid electrolyte layer 5 side towards a second surface s2 which is the anode current collector 2 side. Also, as shown in FIG. 2A, in addition to the mixture layer 6a, the protective layer 6 may include Mg layer 6b containing the Mg but not containing a solid electrolyte, in a position closer to the anode current collector 2 side than the mixture layer 6a side. Also, as shown in FIG. 2B, the protective layer 6 may include a plurality of the mixture layer 6a.

For example, when the all solid state battery shown in FIG. 2A is charged, an anode active material layer containing a deposited Li will be formed between the anode current collector 2 and the solid electrolyte layer 5. In specific, as shown in FIG. 3, anode active material layer 1 containing a deposited Li will be formed between the anode current collector 2 and the solid electrolyte layer 5. In this manner, the all solid state battery in the present disclosure may be a battery utilizing deposition —dissolution reactions of a metal lithium. In FIG. 3, the anode active material layer 1 is formed between the mixture layer 6a and the solid electrolyte layer 5, but depending on the charge conditions and the charge state, there may be cases where the anode active material layer 1 is formed between the mixture layer 6a and Mg layer 6b, and where the anode active material layer 1 is formed between the Mg layer 6b and the anode current collector 2. Also, there may be a case where the mixture layer 6a or the Mg layer 6b may include a void inside, and Li is deposited in that void. Also, it is presumed that the Mg included in the protective layer 6 is alloyed with Li.

According to the present disclosure, a protective layer provided with a mixture layer containing a Mg-containing particle and a solid electrolyte is arranged between the anode current collector and the solid electrolyte layer, and further, in the protective layer, Mg concentration increases stepwisely or continuously from a first surface towards a second surface, and thus occurrence of sort circuit is inhibited in the all solid state battery.

As in Patent Literature 1, in an all solid state battery utilizing depositing and dissolving reactions of a metal lithium as a reaction of an anode, a technique of arranging a metal Mg layer on an anode current collector has been known. By arranging the metal Mg layer, charge and discharge efficiency of the all solid state battery can be improved. Meanwhile, when a current load is high, there is a risk that uneven deposition and dissolution of the metal lithium may occur, and as a result, there is a risk of short circuit occurrence. Also, when Li is deposited unevenly, there is a risk that the deposited Li layer (anode active material layer) may be peeled off. As a result, there is a risk that the battery resistance of the all solid state battery may increase, and there is a risk that the capacity durability may decrease.

In contrast, in the present disclosure, the protective layer is provided with a mixture layer including a Mg-containing particle and a sold electrolyte, and thus occurrence of short circuit is inhibited in the all solid state battery. This is presumably because the solid electrolyte included in the solid electrolyte layer contacts the solid electrolyte included in the mixture layer, and thus the power concentration is suppressed and a local deposition of Li is suppressed to inhibit the occurrence of short circuit. Also, it is considered that the deposited Li is alloyed with the Mg-containing particle, and that Li is dispersed in the alloy. Thereby, it is considered that the deposited Li layer and the mixture layer are adhered by an anchor effect, and the peel-off of the deposited Li layer is suppressed. Further, the peel-off of the deposited Li layer is suppressed, and thus re-dissolution of the deposited Li layer easily occurs during discharge, and the increase in battery resistance can be suppressed. In this manner, the protective layer includes the mixture layer provided with the Mg-containing particle and the solid electrolyte, and thus the input and output characteristics of Li in the interface of the solid electrolyte layer in the anode layer side improves, and the occurrence of short circuit is inhibited in the all solid state battery. Further, in the protective layer, since the Mg concentration increases stepwisely or continuously from the first surface towards the second surface, for example, even when the battery is charged or discharged at a comparatively high rate, occurrence of short circuit can be inhibited.

1. Protective Layer

The protective layer in the present disclosure is a layer arranged between the anode current collector and solid electrolyte layer, and contains Mg. Also, a surface of the protective layer in the solid electrolyte layer side is regarded as a first surface, and a surface of the protective layer in the anode current collector side is regarded as a second surface. For example, the protective layer 6 shown in FIG. 1 includes first surface s1 in the solid electrolyte layer 5 side, and second surface s2 in the anode current collector 2 side.

In the protective layer 6, Mg concentration increases stepwisely or continuously from the first surface s1 towards the second surface s2. The protective layer 6 shown in FIG. 2A includes layers in the order of mixture layer 6a and Mg layer 6b from the solid electrolyte layer 5 side. In this case, the Mg concentration in the Mg layer 6b is usually higher than the Mg concentration in the mixture layer 6a. In other words, the Mg concentration stepwisely increases from the first surface s1 of the protective layer 6 towards the second surface s2 of the protective layer 6. The Mg concentration can be obtained as an atomic composition ratio (atm %) of Mg in each layer. In the present disclosure, the Mg concentration inside the mixture layer 6a may continuously increase in the direction from the first surface towards the second surface. In the same manner, the Mg concentration inside the Mg layer 6b may continuously increase in the direction from the first surface towards the second surface.

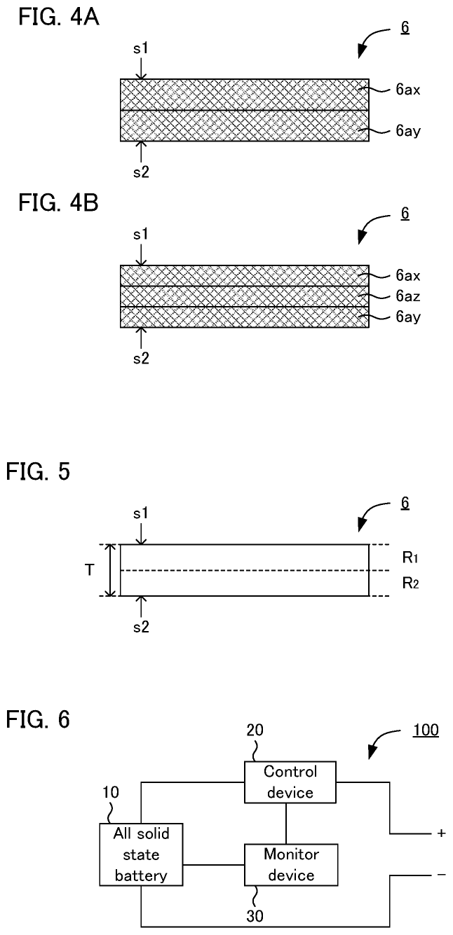

Also, the protective layer may include a plurality of the mixture layer. In some embodiments, the plurality of the mixture layer is continuously arranged. For example, the protective layer 6 shown in FIG. 4A includes layers in the order of mixture layer 6ax and mixture layer 6ay from the solid electrolyte layer 5 side. In this case, the Mg concentration in the mixture layer 6ay is usually higher than the Mg concentration in the mixture layer 6ax. The Mg concentration may be adjusted by, for example, the weight ratio of the Mg-containing particle included in the mixture layer. For this reason, in the direction from the first surface towards the second surface, the weight ratio of the Mg-containing particle in each mixture layer may stepwisely increase. Also, the protective layer 6 shown in FIG. 4B includes layers in the order of mixture layer 6ax, mixture layer 6az, and mixture layer 6ay, from the solid electrolyte layer 5 side. In this case, the Mg concentration in the mixture layer 6ay is usually higher than the Mg concentration in the mixture layer 6az, and the Mg concentration in the mixture layer 6az is higher than the Mg concentration in the mixture layer 6ax.

Also, in a pair of layers neighboring, CA designates the Mg concentration in a layer positioned in the first surface side, and CB designates the Mg concentration in a layer positioned in the second surface side. CB is usually larger than CA. The rate of CB with respect to CA, which is CB/CA is, for example, 1.2 or more, may be 2.0 or more, and may be 5.0 or more. Specific examples of the pair of layers neighboring may include, a combination of the mixture layer and the Mg layer, a combination of two of the mixture layer, and a combination of two of the Mg layer.

Also, as shown in FIG. 5, in the protective layer 6, a region including the first surface s1 is regarded as first region R₁, and a region including the second surface s2 is regarded as second region R₂. The first region R₁ is, when T designates the thickness of the protective layer 6, a region of the protective layer 6 present from the first surface s1 until 0.5T along with the thickness direction. Meanwhile, the second region R₂ is, when T designates the thickness of the protective layer 6, a region of the protective layer 6 present from the second surface s2 until 0.5T along with the thickness direction. In this manner, specific layer constitution is not limited, and the first region R₁ and the second region R₂ are defined. Also, C₁ designates the Mg concentration in the first region R₁, and C₂ designates the Mg concentration in the second region R₂.

C₂ is usually larger than C₁. The rate of C₂ with respect to C₁, which is C₂/C₁ is, for example, 1.2 or more, may be 2.0 or more, and may be 5.0 or more. Also, C₂ is, for example, 50 atm % or more, may be 70 atm % or more, and may be 90 atm % or more. Meanwhile, C₁ is usually larger than 0 atm %.

(1) Mixture Layer

The mixture layer includes a Mg-containing particle containing the Mg, and a solid electrolyte. In the mixture layer, the Mg-containing particle and the solid electrolyte are mixed.

(i) Mg-Containing Particle

The Mg-containing particle contains Mg. The Mg-containing particle may be a particle of a simple substance of Mg (Mg particle), and may be a particle containing Mg and an element other than Mg. Examples of the element other than Mg may include Li and a metal (including half metal) other than Li. Also, an additional example of the element other than Mg may be non-metal such as 0.

On the Mg-containing particle, the core of metal Li tends to be stably formed, and thus more stable precipitation of Li is possible when the Mg-containing particle is used. Also, Mg has wide composition region to form a single phase with Li, and thus more efficient dissolution and deposition of Li is possible.

The Mg-containing particle may be an alloy particle (Mg alloy particle) containing Mg and a metal other than Mg. In some embodiments, the Mg alloy particle is an alloy containing Mg as a main component. Examples of a metal M other than Mg in the Mg alloy particle may include Li, Au, Al and Ni. The Mg alloy particle may contain just one kind of the metal M, and may contain two kinds or more of the metal M. Also, the Mg-containing particle may or may not contain Li. In the former case, the alloy particle may include an alloy of β single phase of Li and Mg.

The Mg-containing particle may be an oxide particle (Mg oxide particle) containing Mg and O. Examples of the Mg oxide particle may include an oxide of a simple substance of Mg, and a composite metal oxide represented by Mg-M′-O, provided that M′ is at least one of Li, Au, Al and Ni. In some embodiments, the Mg oxide particle contains at least Li as M′. M′ may or may not contain a metal other than Li. In the former case, M′ may be one kind of metal other than Li, and may be two or more kinds. Meanwhile, the Mg-containing particle may not contain O.

The Mg-containing particle may be a primary particle, and may be a secondary particle which is aggregation of the primary particles. In some embodiments, the average particle size (D₅₀) of the Mg-containing particle is small. When the average particle size is small, the dispersibility of the Mg-containing particle in the mixture layer improves, and reaction point with Li increases; thus, it is more effective to inhibit short circuit. The average particle size (D₅₀) of the Mg-containing particle is, for example, 500 nm or more, and may be 800 nm or more. Meanwhile, the average particle size (D₅₀) of the Mg-containing particle is, for example, 20 μm or less, may be 10 μm or less, and may be 5 μm or less. Incidentally, as the average particle size, a value calculated from a laser diffraction particle distribution meter, or a value measured based on an image analysis using an electron microscope such as SEM.

Also, the average particle size (D₅₀) of the Mg-containing particle may be the same as the average particle size (D₅₀) of the later described solid electrolyte, and may be larger or smaller than thereof. Here, when X designates the average particle size of the Mg-containing particle, and Y designates the average particle size of the solid electrolyte, the average particle size (D₅₀) of the Mg-containing particle and the average particle size (D₅₀) of the solid electrolyte being the same means that the difference between the two (absolute value of X-Y) is 5 μm or less. The average particle size (D₅₀) of the Mg-containing particle is larger than the average particle size (D₅₀) of the solid electrolyte means that X-Y is larger than 5 μm. In this case, X/Y is, for example, 1.2 or more, may be 2 or more, and may be 5 or more. Meanwhile, X/Y is, for example, 100 or less and may be 50 or less. The average particle size (D₅₀) of the Mg-containing particle is smaller than the average particle size (D₅₀) of the solid electrolyte means that Y-X is larger than 5 μm. In this case, Y/X is, for example, 1.2 or more, may be 2 or more, and may be 5 or more. Meanwhile, Y/X is, for example, 100 or less and may be 50 or less.

The proportion of the Mg-containing particle in the mixture layer is, for example, 10 weight % or more, and may be 30 weight % or more. Meanwhile, the proportion of the Mg-containing particle is, for example, 90 weight % or less, and may be 70 weight % or less.

(ii) Solid Electrolyte

The mixture layer contains a solid electrolyte. Examples of the solid electrolyte may include an inorganic solid electrolyte such as a sulfide solid electrolyte, an oxide solid electrolyte, a nitride solid electrolyte, a halide solid electrolyte, and a complex hydride. In some embodiments, the solid electrolyte is a sulfide solid electrolyte. The sulfide solid electrolyte usually contains sulfur (S) as a main component of the anion element. The oxide solid electrolyte, the nitride solid electrolyte, and the halide solid electrolyte usually contains, as a main component of the anion, oxygen (O), nitrogen (N), and halogen (X) respectively.

In some embodiments, the sulfide solid electrolyte contains, for example, a Li element, an X element (X is at least one kind of P, As, Sb, Si, Ge, Sn, B, Al, Ga, and In), and a S element. Also, the sulfide solid electrolyte may further contain at least one of an 0 element and a halogen element. In some embodiments, the sulfide solid electrolyte contains a S element as a main component of the anion element.

Examples of the sulfide solid electrolyte may include Li₂S—P₂S₅, Li₂S—P₂S₅—LiI, Li₂S—P₂S₅—GeS₂, Li₂S—P₂S₅—Li₂O, Li₂S—P₂S₅—Li₂O—LiI, Li₂S—P₂S₅—LiI—LiBr, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅-ZmSn (provided that m and n is a positive number; Z is any one of Ge, Zn, and Ga), Li₂S—GeS₂, Li₂S—SiS₂—Li₃PO₄, and Li₂S—SiS₂-LiₓMO_{y} (provided that x and y is a positive number; M is any one of P, Si, Ge, B, Al, Ga, and In).

The solid electrolyte may be in a glass shape, and may include a crystal phase. The shape of the solid electrolyte is usually a granular shape. The average particle size (D₅₀) of the solid electrolyte is, for example, 0.01 μm or more. Meanwhile, the average particle size (D₅₀) of the solid electrolyte is, for example, 10 μm or less, and may be 5 μm or less. Ion conductivity of the solid electrolyte at 25° C. is, for example, 1*10⁻⁴ S/cm or more, and may be 1*10⁻³ S/cm or more.

The proportion of the solid electrolyte in the mixture layer is, for example, 10 weight % or more, and may be 30 weight % or more. Meanwhile, the proportion of the solid electrolyte in the mixture layer is, for example, 90 weight % or less, and may be 70 weight % or less. Also, in the mixture layer, the proportion of the Mg-containing particle with respect to the total of the Mg-containing particle and the solid electrolyte is, for example, 10 weight % or more, and may be 30 weight % or more. Meanwhile, the proportion of the Mg-containing particle is, for example, 90 weight % or less, and may be 70 weight % or less.

(iii) Mixture Layer

The mixture layer may contain a binder as required. Thereby, occurrence of a crack of the mixture layer itself can be inhibited. Examples of the binder may include a fluorine-based binder and a rubber-based binder. Examples of the fluorine-based binder may include polyvinylidene fluoride (PVDF) and polytetra fluoroethylene (PTFE). Also, examples of the rubber-based binder may include butadiene rubber (BR), acrylate butadiene rubber (ABR), and styrene butadiene rubber (SBR). The thickness of the mixture layer is, for example, 0.1 μm or more and 1000 μm or less.

The protective layer in the present disclosure may include just one layer of the mixture layer, and may include two layers or more thereof. Also, examples of the method for forming the mixture layer may include a method of pasting a slurry containing at least the Mg-containing particle and the solid electrolyte, on a substrate.

(2) Mg Layer

The protective layer in the present disclosure may include a Mg layer containing the Mg but not containing a solid electrolyte, in a position closer to the anode current collector side than the mixture layer side. By arranging the Mg layer between the anode current collector and the mixture layer, dispersion of Li can be further promoted. Also, since the solid electrolyte included in the mixture layer does not directly contact the anode current collector, the deposition origin of Li can be just on Mg. Thereby, Li can be further uniformly deposited.

The Mg layer is a layer of which proportion of Mg is the most among all the constituents therein. The proportion of Mg in the Mg layer is, for example, 50 atm % or more, may be 70 atm % or more, may be 90 atm % or more, and may be 100 atm %. Examples of the Mg layer may include a metal thin film (such as a vapor deposition film) containing Mg, and a layer including the Mg-containing particle. In some embodiments, the metal thin film containing Mg mainly composed of Mg. Also, the contents of the Mg-containing particle are as described above. The Mg layer may be a layer containing just the Mg-containing particle.

The thickness of the Mg layer is, for example, 10 nm or more and 10 μm or less. Above all, when the Mg layer is the metal thin film containing Mg, the thickness is 5000 nm or less, may be 3000 nm or less, may be 1000 nm or less, and may be 700 nm or less. Meanwhile, the thickness of the Mg layer may be 50 nm or more, and may be 100 nm or more.

The protective layer in the present disclosure may include just one layer of the Mg layer, and may include two layers or more thereof. Meanwhile, the protective layer in the present disclosure may not include the Mg layer. Examples of the method for forming the Mg layer may include a method of forming a film on the anode current collector by a PVD method such as a vapor deposition method and a spattering method or by a plating method such as an electrolyte plating method and a non-electrolyte plating method; and a method of pressing the Mg-containing particle.

Also, as shown in FIG. 2A, the Mg layer 6b and the mixture layer 6a may directly contact each other. Similarly, the mixture layer 6a and the solid electrolyte layer 5 may directly contact each other. Similarly, the Mg layer 6b and the anode current collector 2 may directly contact each other. Also, as shown in FIG. 1 and FIG. 2B, the mixture layer 6a and the anode current collector 2 may directly contact each other.

2. Anode

The anode in the present disclosure includes at least an anode current collector. As shown in FIG. 2A, anode AN may not include an anode active material layer containing deposited Li between the anode current collector 2 and the solid electrolyte layer 5. Also, as shown in FIG. 3, the anode AN may include anode active material layer 1 containing deposited Li between the anode current collector 2 and the solid electrolyte layer 5.

In some embodiments, when the anode includes an anode active material layer, the anode active material layer contains at least one of a simple substance of Li and a Li alloy as an anode active material. Incidentally, in the present disclosure, a simple substance of Li and a Li alloy may be referred to as a Li-based active material in general. When the anode active material layer contains the Li-based active material, the Mg-containing particle in the protective layer may or may not contain Li.

For example, in an all solid state battery produced by using a Li foil or a Li alloy foil as the anode active material, and using a Mg particle as the Mg-containing particle, the Mg particle is presumed to be alloyed with Li at the time of initial discharge. Meanwhile, in an all solid state battery produced by not arranging an anode active material layer, but using a Mg particle as the Mg-containing particle, and using a cathode active material containing Li, the Mg particle is presumed to be alloyed with Li at the time of initial charge.

The anode active material layer may contain just one of a simple substance of Li and a Li alloy as the Li-based active material, and may contain the both of a simple substance of Li and a Li alloy.

In some embodiments, the Li alloy is an alloy containing a Li element as a main component. Examples of the Li alloy may include Li—Au, Li—Mg, Li—Sn, Li—Al, Li—B, Li—C, Li—Ca, Li—Ga, Li—Ge, Li—As, Li—Se, Li—Ru, Li—Rh, Li—Pd, Li—Ag, Li—Cd, Li—In, Li—Sb, Li—Ir, Li—Pt, Li—Hg, Li—Pb, Li—Bi, Li—Zn, Li—Tl, Li—Te and Li—At. The Li alloy may be just one kind, and may be two kinds or more.

Examples of the shape of the Li-based active material may include a foil shape and a granular shape. Also, the Li-based active material may be a deposited metal lithium.

The thickness of the anode active material layer is not particularly limited; for example, it is 1 nm or more and 1000 μm or less, and may be 1 nm or more and 500 μm or less.

Examples of the material for the anode current collector may include SUS, Cu, Ni, In, Al and C. Examples of the shape of the anode current collector may include a foil shape, a mesh shape, and a porous shape. Also, the surface of the anode current collector may or may not be subjected to a roughening treatment. Smooth surface of the anode current collector is desirable from the viewpoint of wettability. Also, rough surface of the anode current collector is desirable from the viewpoint that the contact area of the anode current collector increases. When the contact area increases, the interface bonding will be stronger, and peel-off of materials may be further inhibited. The surface roughness (Ra) of the anode current collector is, for example, 0.1 μm or more, may be 0.3 μm or more, and may be 0.5 μm or more. Meanwhile, the surface roughness (Ra) of the anode current collector is, for example, 5 μm or less and may be 3 μm or less. The surface roughness (Ra) can be obtained by a method according to JIS B0601.

4. Cathode

In some embodiments, the cathode in the present disclosure includes a cathode active material layer and a cathode current collector. The cathode active material layer in the present disclosure is a layer containing at least a cathode active material. Also, the cathode active material layer may contain at least one of a solid electrolyte, a conductive material, and a binder, as required.

The cathode active material is not particularly limited if it is an active material having higher reaction potential than that of the anode active material, and cathode active materials that can be used in an all solid state battery may be used. The cathode active material may or may not contain a lithium element.

Examples of the cathode active material including a lithium element may include a lithium oxide. Examples of the lithium oxide may include a rock salt bed type active material such as LiCoO₂, LiMnO₂, LiNiO₂, LiVO₂, and LiNi_{1/3}Co_{1/3}Mn_{1/3}O₂; a spinel type active material such as Li₄Ti₅O₁₂, LiMn₂O₄, LiMn_{1.5}Al_{0.5}O₄, LiMn_{1.5}Mg_{0.5}O₄, LiMn_{1.5}Co_{0.5}O₄, LiMn_{1.5}Fe_{0.5}O₄, and LiMn_{1.5}Zn_{0.5}O₄; and an olivine type active material such as LiFePO₄, LiMnPO₄, LiNiPO₄, and LiCoPO₄. Also, additional examples of the cathode active material including a lithium element may include LiCoN, Li₂SiO₃, Li₄SiO₄, a lithium sulfide (Li₂S), and a lithium polysulfide (Li₂Sₓ, 2≤x≤8).

Meanwhile, examples of the cathode active material not including a lithium element may include a transition metal oxide such as V₂O₃ and MoO₃; a S-based active material such as S and TiS₂; a Si-based active material such as Si and SiO; and a lithium storing intermetallic compound such as Mg₂Sn, Mg₂Ge, Mg₂Sb and Cu₃Sb.

Also, a coating layer containing an ion conductive oxide may be formed on the surface of the cathode active material. The coating layer prevents the reaction of the cathode active material and the solid electrolyte. Examples of the ion conductive oxide may include LiNbO₃, Li₄Ti₅O₁₂, and Li₃PO₄.

The proportion of the cathode active material in the cathode active material layer is, for example, 20 weight % or more, may be 30 weight % or more and may be 40 weight % or more. Meanwhile, the proportion of the cathode active material in the cathode active material layer is, for example, 80 weight % or less, may be 70 weight % or less and may be 60 weight % or less.

Examples of the conductive material may include a carbon material. Specific examples of the carbon material may include acetylene black, Ketjen black, VGCF and graphite. The solid electrolyte and the binder are in the same contents as those described in “1. Protective layer”. Also, the thickness of the cathode active material layer is, for example, 0.1 μm or more and 1000 μm or less.

The cathode current collector is, for example, arranged in the opposite side to the solid electrolyte layer on the basis of the cathode active material layer. Examples of the material for the cathode current collector may include Al, Ni and C. Examples of the shape of the cathode current collector may include a foil shape, a mesh shape, and a porous shape.

5. Solid Electrolyte Layer

The solid electrolyte layer in the present disclosure is a layer containing at least a solid electrolyte. Also, the solid electrolyte layer may contain a binder as required. The solid electrolyte and the binder are in the same contents as those described in “1. Protective layer”.

In some embodiments, the solid electrolyte included in the solid electrolyte layer and the solid electrolyte included in the mixture layer are a same kind of solid electrolyte. The reason therefor is to improve the adherence of the solid electrolyte layer and the mixture layer. In some embodiments, when the solid electrolyte included in the solid electrolyte layer is a sulfide solid electrolyte, the solid electrolyte included in the mixture layer is also the sulfide solid electrolyte. The same applies when other inorganic solid electrolytes such as an oxide solid electrolyte, and a nitride solid electrolyte are used instead of the sulfide solid electrolyte. Also, the thickness of the solid electrolyte layer is, for example, 0.1 μm or more and 1000 μm or less.

6. All Solid State Battery

The all solid state battery in the present disclosure may further include a restraining jig that applies a restraining pressure along with the thickness direction of the cathode, the solid electrolyte layer and the anode. As the restraining jig, known jigs may be used. The restraining pressure is, for example, 0.1 MPa or more and may be 1 MPa or more. Meanwhile, the restraining pressure is, for example, 50 MPa or less, may be 20 MPa or less, may be 15 MPa or less, and may be 10 MPa or less.

The kind of the all solid state battery in the present disclosure is not particularly limited, but is typically a lithium ion secondary battery. The all solid state battery in the present disclosure may be a single battery and may be a layered battery. The layered battery may be a monopolar layered battery (layered battery connected in parallel), and may be a bipolar layered battery (layered battery connected in series). Examples of the shape of the battery may include a coin shape, a laminate shape, a cylindrical shape and a square shape.

Examples of the applications of the all solid state battery in the present disclosure may include a power source for vehicles such as hybrid electric vehicles (HEV), plug-in hybrid electric vehicles (PHEV), battery electric vehicles (BEV), gasoline-fueled automobiles and diesel powered automobiles. Also, the all solid state battery in the present disclosure may be used as a power source for moving bodies other than vehicles (such as rail road transportation, vessel and airplane), and may be used as a power source for electronic products such as information processing equipment.

B. All Solid State Battery System

FIG. 6 is a schematic diagram exemplifying the all solid state battery system in the present disclosure. All solid state battery system 100 shown in FIG. 6 includes all solid state battery 10, and control device 20 that controls charge and discharge of the all solid state battery 10. Also, the all solid state battery system 100 includes monitor device 30 that monitors the state of the all solid state battery 10, and the control device 20 acquires information relating to the state of the all solid state battery 10 from the monitor device 30. The all solid state battery system 100 includes the above described all solid state battery as the all solid state battery 10, and the control device 20 controls the all solid state battery 10 to be charged or discharged at a comparatively high rate.

According to the present disclosure, even when the above described all solid state battery is charged or discharged at a comparatively high rate, occurrence of short circuit can be inhibited.

1. All Solid State Battery

The all solid state battery in the present disclosure is in the same contents as those described in “A. All solid state battery” above; thus, the descriptions herein are omitted.

2. Control Device

The control device in the present disclosure controls the all solid state battery to be charged or discharged at a rate of 0.5 C or more. The control device may control the all solid state battery to be charged or discharged at the rate of 1.0 C or more. Also, the control device may control the all solid state battery to be charged or discharged at the rate of, for example, not over 3.0 C.

3. All Solid State Battery System

The all solid state battery system in the present disclosure may include a monitor device that monitors the state of the all solid state battery. Examples of the monitor device may include a current sensor, a voltage sensor and a temperature sensor.

Incidentally, the present disclosure is not limited to the embodiments. The embodiments are exemplification, and any other variations are intended to be included in the technical scope of the present disclosure if they have substantially the same constitution as the technical idea described in the claims of the present disclosure and have similar operation and effect thereto.

### EXAMPLES

### Example 1

<Production of Mixture Layer>

A binder solution (styrene butadiene solution) and a solvent (mesitylene and dibutylether) were projected into a container made of PP (polypropylene), and mixed for 3 minutes by a shaker. After that, a Mg particle (average particle size D₅₀=800 nm), and a solid electrolyte particle (sulfide solid electrolyte, 10LiI-15LiBr-75Li3PS4, average particle size D₅₀=800 nm) were weighed so as to be the Mg particle: the solid electrolyte particle=50: 50 in the weight ratio, and projected into the container made of PP. The mixture was treated for 3 minutes by the shaker, treated for 30 seconds by an ultrasonic dispersion device, and the treatments were repeated twice to produce slurry. Successively, the slurry was pasted on a substrate (Al foil) using an applicator with 25 μm pasting gap and dried naturally. After confirming that the surface was dried visually, the product was dried for 30 minutes on a hot plate at 100° C. Thereby, a transfer member with a mixture layer formed on the substrate was produced.

<Production of Mg Layer>

By a vapor deposition method, a Mg layer (vapor deposition layer, thickness: 700 nm) was formed on an anode current collector (SUS foil). Thereby, an anode current collector including the Mg layer was obtained.

<Production of Cathode Mixture>

A cathode active material (LiNi_{1/3}Co_{1/3}Mn_{1/3}O₂), a sulfide solid electrolyte (10LiI-15LiBr-75Li3PS4, average particle size D₅₀=0.5 μm), and a conductive material (vapor grown carbon fiber, VGCF) were respectively weighed so as to be 800 mg, 127 mg, and 12 mg. These were dispersed in a dehydrated heptane using an ultrasonic homogenizer. The obtained dispersion was dried for 1 hour at 100° C. to obtain a cathode mixture.

<Production of all Solid State Battery>

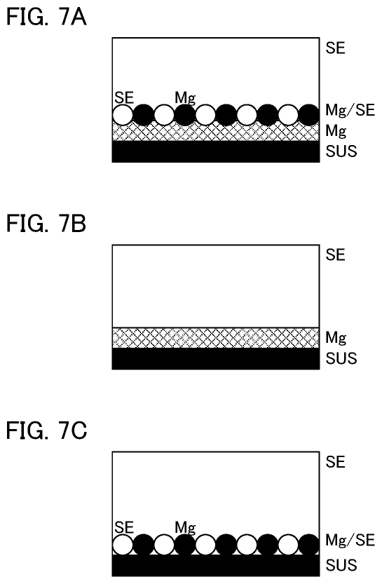

An all solid state battery of a powder pressure type pressed cell (φ1.28 mm) was produced. In specific, 101.7 mg of a sulfide solid electrolyte (10LiI-15LiBr-75Li3PS4, average particle size D₅₀=0.5 μm) was put in a cylinder, pressed for 1 minute at the pressure of 1 ton, and thereby a solid electrolyte layer was obtained. Next, 31.3 mg of the cathode mixture was added to one surface of the solid electrolyte layer, pressed for 1 minute at the pressure of 6 tons, and thereby a cathode active material layer was obtained. Next, the transfer member was layered on the other surface of the solid electrolyte layer so as to contact the solid electrolyte layer and the mixture layer, and the product was pressed at 1 ton, and then the Al foil was peeled off. The anode current collector (SUS foil) including the Mg layer was arranged so that the exposed mixture layer contacted the Mg layer, pressed for 1 minute at the pressure of 1 ton, and thereby an electrode body was obtained. This electrode body was restrained by a torque of 0.2 N·m using three bolts. Thereby, an all solid state battery was obtained. In the obtained all solid state battery, as shown in FIG. 7A, the mixture layer (Mg/SE) and the Mg layer (vapor deposition layer) were arranged between the solid electrolyte layer (SE) and the anode current collector (SUS).

### Comparative Example 1

An all solid state battery was obtained in the same manner as in Example 1 except that the mixture layer was not arranged. In the obtained all solid state battery, as shown in FIG. 7B, the Mg layer (vapor deposition layer) was arranged between the solid electrolyte layer (SE) and the anode current collector (SUS).

### Comparative Example 2

An all solid state battery was obtained in the same manner as in Example 1 except that the Mg layer was not arranged. In the obtained all solid state battery, as shown in FIG. 7C, the mixture layer (Mg/SE) was arranged between the solid electrolyte layer (SE) and the anode current collector (SUS).

[Evaluation]

<Charge and Discharge Evaluation>

The all solid state batteries obtained in Example 1 and Comparative Examples 1 to 2 were placed still in a thermostatic tank at 60° C. for 3 hours. After that, the batteries were charged and discharged at 0.1 C for 3 cycles. Next, the batteries were charged and discharged at 0.5 C for 3 cycles. Next, the batteries were charged and discharged at 1 C for 3 cycles. The average capacity (capacity durability) when the discharge capacity at 0.1 C in the first cycle was regarded as 100%, at each rate was calculated. The results are shown in Table 1.

TABLE 1

| | | Charge and | Capacity |
|---|---|---|---|
| | Protective | discharge | durability |
| | layer | rate | [%] |
| Example 1 | Mixture | 0.1 C | 100 |
| | layer + | 0.5 C | 88.85 |
| | Mg layer | 1.0 C | 73.70 |
| Comparative | Mg layer | 0.1 C | 98.87 |
| Example 1 | | 0.5 C | 80.09 |
| | | 1.0 C | 58.99 |
| Comparative | Mixture | 0.1 C | 100 |
| Example 2 | layer | 0.5 C | 84.58 |
| | | 1.0 C | 67.58 |

As shown in Table 1, it was suggested that Example 1 had higher capacity durability than that of Comparative Examples 1 to 2, and the occurrence of short circuit was inhibited. Also, in Example 1, the capacity durability was maintained high also at 0.5 C and 1.0 C.

### REFERENCE SIGNS LIST

1 anode active material layer
2 anode current collector
3 cathode active material layer
4 cathode current collector
5 solid electrolyte layer
6 protective layer
6a mixture layer
6b Mg layer
10 all solid state battery

What is claimed is:

1. An all solid state battery comprising an anode including at least an anode current collector, a cathode, and a solid electrolyte layer arranged between the anode and the cathode; wherein
a protective layer containing Mg is arranged between the anode current collector and the solid electrolyte layer;
the protective layer includes a mixture layer including a Mg-containing particle containing the Mg, and a solid electrolyte; and
in the protective layer, Mg concentration increases stepwisely or continuously from a first surface which is the solid electrolyte layer side towards a second surface which is the anode current collector side.

2. The all solid state battery according to claim 1, wherein the protective layer includes a Mg layer containing the Mg but not containing a solid electrolyte, in a position closer to the anode current collector side than the mixture layer side.

3. The all solid state battery according to claim 2, wherein the Mg layer is a metal thin film containing the Mg.

4. The all solid state battery according to claim 3, wherein a thickness of the metal thin film is 1 nm or more and 5000 nm or less.

5. The all solid state battery according to claim 2, wherein the Mg layer is a layer including the Mg-containing particle containing the Mg.

6. The all solid state battery according to claim 1, wherein the protective layer includes a plurality of the mixture layer.

7. The all solid state battery according to claim 1, wherein the anode includes an anode active material layer containing a deposited Li between the anode current collector and the solid electrolyte layer.

8. The all solid state battery according to claim 1, wherein the anode does not include an anode active material layer containing a deposited Li between the anode current collector and the solid electrolyte layer.

9. An all solid state battery system comprising:
an all solid state battery according to claim 1; and
a control device that controls charge and discharge of the all solid state battery; wherein
the control device controls the all solid state battery to be charged or discharged at a rate of 0.5 C or more.
